(19) United States
(12) Patent Application Publication
(10) Pub. No.: US 2019/0102469 A1
(43) Pub. Date: Apr. 4, 2019

(54) SMART PRIORITY SYSTEM FOR ENTERPRISE ALERTS

(71) Applicant: ServiceNow, Inc., Santa Clara, CA (US)

(72) Inventors: Bnayahu Makovsky, Savyon (IL); Netta Hasdai, Tel Aviv (IL); Vadim Shif, Tel Aviv (IL); Adar Margalit, Moddin (IL); Yotam Barak, Tel Aviv (IL)

(21) Appl. No.: 15/723,717

(22) Filed: Oct. 3, 2017

(51) Int. Cl. G06F 17/30

(52) U.S. Cl. CPC G06F 17/30867; G06F 17/30991

(57) ABSTRACT

Various embodiments are disclosed herein that provide users of a cloud computing system with the ability to display, prioritize, and/or handle enterprise alerts, e.g., in the form of a sorted list. In some embodiments, these alerts may be ranked according to a ‘smart priority’ calculation. The ‘smart priority’ calculation may take into account a number of factors related to given alert, e.g.: severity level, business criticality level, role, number of affected system components, types of affected system components, etc. These factors may be combined in the ‘smart priority’ calculation in a hierarchical fashion, e.g., based on a predetermined (or user-customized ranking) of the importance and/or weighting of the various factors. By seeing the historical and status metadata information relating to the alerts, users may more quickly understand which alerts to address first—and what possible solutions may be employed in order to close out the open alerts in the system.

### TECHNICAL FIELD

The embodiments described herein relate generally to configuration management databases (CMDBs) and, more particularly, to scoring and/or prioritizing enterprise alerts in an intelligent fashion.

### BACKGROUND

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing based services. By doing so, users are able to access computing resources on demand that are located at remote locations, which resources may be used to perform a variety computing functions, e.g., storing and/or processing large quantities of computing data. For enterprise and other organization users, cloud computing provides flexibility in accessing cloud computing resources without accruing large up-front costs, such as purchasing expensive network equipment or investing large amounts of time in establishing a private network infrastructure. Instead, by utilizing cloud computing resources, users are able redirect their resources to focus on their enterprise's core functions.

In today's communication networks, examples of cloud computing services a user may utilize include so-called software as a service (SaaS) and platform as a service (PaaS) technologies. SaaS is a delivery model that provides software as a service rather than an end product. Instead of utilizing a local network or individual software installations, software is typically licensed on a subscription basis, hosted on a remote machine, and accessed by client customers as needed. For example, users are generally able to access a variety of enterprise and/or information technology (IT)-related software via a web browser. PaaS acts an extension of SaaS that goes beyond providing software services by offering customizability and expandability features to meet a user's needs. For example, PaaS can provide a cloud-based developmental platform for users to develop, modify, and/or customize applications and/or automating enterprise operations without maintaining network infrastructure and/or allocating computing resources normally associated with these functions.

Within the context of cloud computing solutions for CMDBs, users may be asked to deal with ever increasing amounts of data, e.g., with respect to the number of Configuration Items (CIs) stored in the CMDB (including such CIs' relevant metadata, such as manufacturer, vendor, location, etc.), as well as the alerts, service metrics, and maintenance status information related to such CIs. In fact, the amount of data collected and stored in today's cloud computing solutions, such as CMDBs, may be orders of magnitude greater than what was historically collected and stored. Users tasked with automating and/or troubleshooting business, IT, and/or other organization-related functions (e.g., incident tracking and/or help desk-related functions) may be required to navigate ever increasing amounts of data to properly and efficiently perform their job functions. As a result, it can be difficult for users of such CMDBs to appreciate or understand how the various alerts raised within an enterprise system compare to each other, e.g., with respect to severity, business criticality, number of affected system components, etc. Thus, triaging times, debugging times, root cause analysis, and general alert prioritization and management continue to be potential areas of improvement for software developers and application vendors. The following embodiments address improvements to the presentation and prioritization of enterprise alerts to address at least these and other issues relating to the recommendation of corrective actions and/or probable causes of alerts, in order to provide an enhanced user experience.

### SUMMARY

The following presents a simplified summary of the disclosed subject matter in order to provide a basic understanding of some aspects of the subject matter disclosed herein. This summary is not an exhaustive overview of the technology disclosed herein. It is not intended to identify key or critical elements of the invention or to delineate the scope of the invention. Its sole purpose is to present some concepts in a simplified form as a prelude to the more detailed description that is discussed later.

In one embodiment, a system that provides the ability to display and/or traverse the various enterprise alerts comprises, a first trigger queue for storing alert triggers, a second trigger queue for storing changes in the topology or status of CIs stored in the CMDB, a smart priority score calculation module, a non-transitory memory, and one or more hardware processors configured to read instructions from the non-transitory memory. When executed, the instructions can cause the one or more hardware processors to store one or more alert items in the aforementioned first trigger queue and store one or more topology change items or service status change items in the aforementioned second trigger queue.

A processing job may be run (e.g., at a predetermined interval or in response to updates to the various trigger queues) to identify each alert item in the first trigger queue needing further processing, e.g., to update the priority score of the respective alert. To calculate the priority store for a respective alert, the system may first obtain a score value, e.g., from a category mapping table, in each of one or more categories. The value of each score may be configured to relate to a characteristic or degree of the corresponding category in the respective alert item. For example, an alert severity value of ‘critical’ may map to a score value of ‘4’, whereas an alert severity value of ‘minor’ may map to a score value of ‘2,’ depending on what is specified in a category mapping table for the ‘alert severity’ category. Next, the system may obtain a weight value, e.g., from a category order table, corresponding to each of the one or more categories, wherein each weight value relates to an importance or criticality of the corresponding category. For example, the alert severity category may have a weight value of 100,000, whereas another category of alert characteristic may have a weight value of 10.

Finally, the system may calculate, e.g., with a priority score calculation module, a so-called ‘smart priority’ score for the respective alert item, e.g., by adding together the products of each of the one or more score values for the respective alert item and its corresponding weight value. In some embodiments, the ‘smart priority’ score may be further enhanced via the application of supervised or semi-supervised machine learning techniques to historical user activity data for the CMDB. Based on the needs of a given implementation, the priority scores of open alerts pending in the system may be recalculated at predetermined intervals or in response to the storage of a trigger object indicating a change in system conditions that affects (or potentially affects) the priority level of a given alert.

In some embodiments, the system also provides an improved user interface for displaying the one or more alert items, e.g., wherein the one or more alert items are sorted in a ranked list based, at least in part, on their respective priority scores. In some embodiments, the user interface may also group the various alert items into ‘buckets,’ e.g., based on the criticality of the alerts in each respective group, such as “High,” “Medium,” and “Low.” The user interface may also present the user with a wide array of other relevant information regarding the one or more alert items, such as: the source of an alert; the name or type of CI affected by an alert; the node or IP address where an alert was raised; the identity of a user assigned to an alert; the location of an alert; the name, number, and/or owner of business services impacted by the alert; historical metrics related to the alert; as well as various potential options for resolving, reporting, or notifying others about a given alert.

According to still other embodiments, the user interface may provide further insights to a user regarding a given alert, e.g.: how often a given alert (or type of alert) has been repeated for the current CI (or related CIs); the incident history for the current CI (or related CIs); the changes history for the current CI (or related CIs); and/or the logged bug history for the current CI (or related CIs). These insights may also include suggestions of how to resolve the alert and/or links to articles explaining the alert and possible corrective actions that may be taken (or that have been successfully taken in the past).

In other embodiments, methods to perform the various enterprise alert prioritizing and presentation techniques summarized above are disclosed. In still other embodiments, non-transitory program storage devices are disclosed, which are readable by programmable control devices and which store instructions configured to cause one or more programmable control devices to perform the various alert presentation and prioritization techniques summarized above.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 is a block diagram of an embodiment of a cloud computing system where embodiments of the present disclosure may operate.

FIG. 2 is a block diagram of an embodiment of a multi-instance cloud architecture where embodiments of the present disclosure may operate.

FIG. 3 is a block diagram of components and interactions of those components, according to one or more embodiments of the present disclosure.

FIG. 4A is a simplified diagram of various database tables, according to one or more embodiments of the present disclosure.

FIG. 4B illustrates an exemplary alert smart priority calculation, according to one or more embodiments of the present disclosure.

FIG. 5 illustrates various components of a system for calculating smart priorities for alert records, according to one or more embodiments of the present disclosure.

FIG. 6 illustrates an exemplary user interface page for viewing information related to alert records, according to one or more embodiments of the present disclosure.

FIG. 7 illustrates another exemplary user interface page for viewing information related to alert records, according to one or more embodiments of the present disclosure.

FIG. 8 is a flowchart of an embodiment of a method that calculates smart priorities for alert records.

FIG. 9 is a block diagram illustrating an embodiment of a computing system for use with techniques described herein.

### DESCRIPTION OF EMBODIMENTS

In the following description, for purposes of explanation, numerous specific details are set forth in order to provide a thorough understanding of the embodiments disclosed herein. It will be apparent, however, to one skilled in the art that the disclosed embodiments may be practiced without these specific details. In other instances, structure and devices are shown in block diagram form in order to avoid obscuring the disclosed embodiments. References to numbers without subscripts or suffixes are understood to reference all instance of subscripts and suffixes corresponding to the referenced number. Moreover, the language used in this disclosure has been principally selected for readability and instructional purposes, and may not have been selected to delineate or circumscribe the inventive subject matter, resort to the claims being necessary to determine such inventive subject matter. Reference in the specification to “one embodiment” or to “an embodiment” means that a particular feature, structure, or characteristic described in connection with the embodiments is included in at least one embodiment.

The terms “a,” “an,” and “the” are not intended to refer to a singular entity, unless explicitly so defined, but, rather, are intended to include the general class of which a specific example may be used for illustration. The use of the terms “a” or “an” may therefore mean any number that is at least one, including “one,” “one or more,” “at least one,” and “one or more than one.” The term “or” means any of the alternatives and any combination of the alternatives, including all of the alternatives, unless the alternatives are explicitly indicated as mutually exclusive. The phrase “at least one of” when combined with a list of items, means a single item from the list or any combination of items in the list. The phrase does not require all of the listed items unless explicitly so defined.

As used herein, the term “computing system” refers to a single electronic computing device that includes, but is not limited to a single computer, virtual machine, virtual container, host, server, laptop, and/or mobile device, or to a plurality of electronic computing devices working together to perform the function described as being performed on or by the computing system.

As used herein, the term “medium” refers to one or more non-transitory physical media that together store the contents described as being stored thereon. Embodiments may include non-volatile secondary storage, read-only memory (ROM), and/or random-access memory (RAM).

As used herein, the term “application” refers to one or more computing modules, programs, processes, workloads, threads and/or a set of computing instructions executed by a computing system. Example embodiments of an application include software modules, software objects, software instances and/or other types of executable code.

As used herein, the term “configuration item” or “CI” refers to a record for any component (e.g., computer, device, piece of software, database table, script, webpage, piece of metadata, etc.) in an enterprise network, for which all relevant data, such as manufacturer, vendor, location, etc. is stored in a CMDB.

Various embodiments are disclosed herein that provide users of a cloud computing system with the ability to display, prioritize, and/or handle enterprise alerts, e.g., in the form of a sorted list. In some embodiments, these alerts may be ranked according to a ‘smart priority’ calculation. The ‘smart priority’ calculation may take into account a number of factors related to given alert, e.g.: severity level, business criticality level, role, number of affected system components, types of affected system components, etc. These factors may be combined in the ‘smart priority’ calculation in a hierarchical fashion, e.g., based on a predetermined (or user-customized ranking) of the importance and/or weighting of the various factors. By seeing the historical and status metadata information relating to the alerts, users may more quickly understand which alerts to address first—and what possible solutions may be employed in order to close out the open alerts in the system.

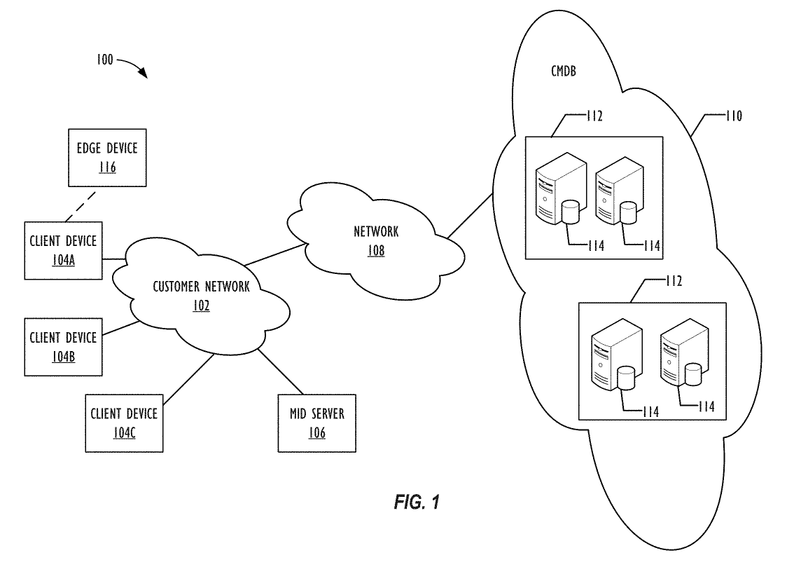

Turning now to FIG. 1, a schematic diagram of an embodiment of a computing system 100, such as a cloud computing system, where embodiments of the present disclosure may operate, is illustrated. Computing system 100 may include a client network 102, network 108 (e.g., the Internet), and CMDB platform 110 network. In one embodiment, the customer network 102 may be a local private network, such as local area network (LAN) that includes a variety of network devices that include, but are not limited to switches, servers, and routers. In another embodiment, the customer network 102 represents an enterprise network that could include one or more LANs, virtual networks, data centers 112, and/or other remote networks. As shown in FIG. 1, the customer network 102 is able to connect to one or more client devices 104A-C so that the client devices are able to communicate with each other and/or with the network hosting the CMDB platform service 110. The client devices 104A-C may be computing systems and/or other types of computing devices generally referred to as Internet of Things (IoT) devices that access cloud computing services, for example, via a web browser application or via an edge device 116 that may act as a gateway between the client device and a remote device. FIG. 1 also illustrates that the customer network 102 includes a management, instrumentation, and discovery (MID) server 106 that facilitates communication of data between the network hosting the CMDB platform service 110, other external applications, data sources, and services, and the customer network 102. Although not specifically illustrated in FIG. 1, the customer network 102 may also include a connecting network device (e.g., a gateway or router) or a combination of devices that implement a customer firewall or intrusion protection system.

FIG. 1 illustrates that customer network 102 is coupled to a network 108. The network 108 may include one or more computing networks available today, such as other LANs, wide area networks (WAN), the Internet, and/or other remote networks, in order to transfer data between the client devices 104A-C and the network hosting the CMDB platform service 110. Each of the computing networks within network 108 may contain wired and/or wireless programmable devices that operate in the electrical and/or optical domain. For example, network 108 may include wireless networks, such as cellular networks (e.g., Global System for Mobile Communications (GSM) based cellular network), WiFi® networks (WIFI is a registered trademark owned by WiFi Alliance Corporation)), and/or other suitable radio-based network as would be appreciated by one of ordinary skill in the art upon viewing this disclosure. The network 108 may also employ any number of network communication protocols, such as Transmission Control Protocol (TCP) and Internet Protocol (IP). Although not explicitly shown in FIG. 1, network 108 may include a variety of network devices, such as servers, routers, network switches, and/or other network hardware devices configured to transport data over networks.

In FIG. 1, the network hosting the CMDB platform service 110 may be a remote network (e.g., a cloud network) that is able to communicate with the client devices 104A-C via the customer network 102 and network 108. The network hosting the CMDB platform service 110 provides additional computing resources to the client devices 104A-C and/or customer network 102. For example, by utilizing the network hosting the CMDB platform service 110, users of client devices 104A-C are able to build and execute applications, such as CMDBs or other automated processes for various enterprise, IT, and/or other organization-related functions, such as alert processing and handling. In one embodiment, the network hosting the CMDB platform service 110 includes one or more data centers 112, where each data center 112 could correspond to a different geographic location. Each of the data center 112 includes a plurality of server instances 114, where each server instance 114 can be implemented on a physical computing system, such as a single electronic computing device (e.g., a single physical hardware server) or could be in the form a multi-computing device (e.g., multiple physical hardware servers). Examples of server instances 114 include, but are not limited to a web server instance (e.g., a unitary Apache installation), an application server instance (e.g., unitary Java® Virtual Machine), and/or a database server instance, e.g., a unitary MySQL® catalog (MySQL® is a registered trademark owned by MySQL AB A COMPANY).

To utilize computing resources within the developmental platform network 110, network operators may choose to configure the data centers 112 using a variety of computing infrastructures. In one embodiment, one or more of the data centers 112 are configured using a multi-tenant cloud architecture, such that a single server instance 114, which can also be referred to as an application instance, handles requests and serves multiple customers. In other words, data centers with multi-tenant cloud architecture commingle and store data from multiple customers, where multiple customer instances are assigned to a single server instance 114. In a multi-tenant cloud architecture, the single server instance 114 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure to single server instance 114 causing outages for all customers allocated to the single server instance 114.

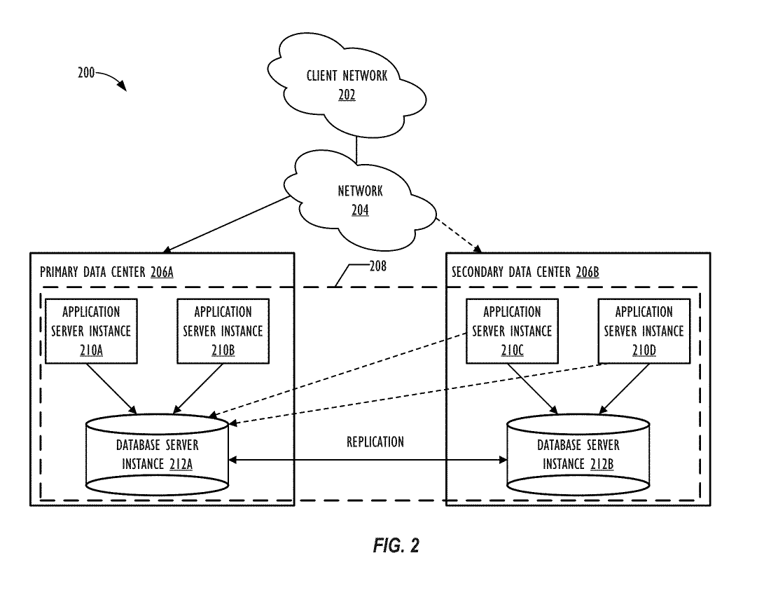

In another embodiment, one or more of the data centers 112 are configured using a multi-instance cloud architecture to provide every customer its own unique customer instance. For example, a multi-instance cloud architecture could provide each customer instance with its own dedicated application server and dedicated database server. In other examples, the multi-instance cloud architecture could deploy a single server instance 114 and/or other combinations of server instances 114, such as one or more dedicated web server instances, one or more dedicated application server instances, and one or more database server instances, for each customer instance. In a multi-instance cloud architecture, multiple customer instances could be installed on a single physical hardware server, where each customer instance is allocated certain portions of the physical server resources, such as computing memory, storage, and processing power. By doing so, each customer instance has its own unique software stack that provides the benefit of data isolation, relatively less downtime for customers to access the developmental platform network 110, and customer-driven upgrade schedules. An example of implementing a customer instance within a multi-instance cloud architecture will be discussed in more detail below with reference to FIG. 2.

In one embodiment, a customer instance may include one or more additional database tables for storing information describing one or more enterprise alerts and the various categories, values, and relative priorities of such alerts. The CMDB system may also include one or more database listeners that can listen for changes (e.g., additions, deletions, updates, etc.) to various tables on client instances and update one or more additional database tables, also referred to herein as “trigger queues,” based on any relevant changes that have taken place with respect to the various CIs in a system that may necessitate a recalculation of the priority score of one or more enterprise alerts stored in the system. After characterizing, scoring, and prioritizing the alerts open in the system, a list-like structure (e.g., a sorted list consisting of one or more alerts and their relevant metadata) may be generated to allow a user to visualize the importance, historical record, and other relevant information for each such alert—including potential troubleshooting or notification options.

FIG. 2 is a schematic diagram of an embodiment of a multi-instance cloud architecture 200 where embodiments of the present disclosure may operate. FIG. 2 illustrates that the multi-instance cloud architecture 200 includes a client network 202 that connects to two data centers 206a and 206b via network 204. Client network 202 and network 204 may be substantially similar to client network 102 and network 108 as described in FIG. 1, respectively. Data centers 206a and 206b can correspond to FIG. 1's data centers 112 located within developmental platform network 110. Using FIG. 2 as an example, a client instance 208 is composed of four dedicated application server instances 210a-210d and two dedicated database server instances 212a and 212b. Stated another way, the application server instances 210a-210d and database server instances 212a and 212b are not shared with other client instances 208. Other embodiments of the multi-instance cloud architecture 200 could include other types of dedicated server instances, such as a web server instance. For example, the client instance 208 could include the four dedicated application server instances 210a-210d, two dedicated database server instances 212a and 212b, and four dedicated web server instances (not shown in FIG. 2).

To facilitate higher availability of the client instance 208, the application server instances 210a-210d and database server instances 212a and 212b are allocated to two different data centers 206a and 206b, where one of the data centers 206 acts as a backup data center. In reference to FIG. 2, data center 206a acts as a primary data center 206a that includes a primary pair of application server instances 210a and 210b and the primary database server instance 212a for the client instance 208, and data center 206b acts as a secondary data center 206b to back up the primary data center 206a for a client instance 208. To back up the primary data center 206a for the client instance 208, the secondary data center 206 includes a secondary pair of application server instances 210c and 210d and a secondary database server instance 212b. The primary database server instance 212a is able to replicate data to the secondary database server instance 212b.

As shown in FIG. 2, the primary database server instance 212a may replicate data to the secondary database server instance 212b using, e.g., a Master-Master MySQL Binlog replication operation. The replication of data between data could be implemented by performing full backups weekly and daily incremental backups in both data centers 206a and 206b. Having both a primary data center 206a and secondary data center 206b allows data traffic that typically travels to the primary data center 206a for the client instance 208 to be diverted to the second data center 206b during a failure and/or maintenance scenario. Using FIG. 2 as an example, if the application server instances 210a and 210b and/or primary data server instance 212a fails and/or is under maintenance, data traffic for client instances 208 can be diverted to the secondary application server instances 210c and the secondary database server instance 212b for processing.

Although FIGS. 1 and 2 illustrate specific embodiments of a cloud computing system 100 and a multi-instance cloud architecture 200, respectively, the disclosure is not limited to the specific embodiments illustrated in FIGS. 1 and 2. For instance, although FIG. 1 illustrates that the developmental platform network 110 is implemented using data centers, other embodiments of the of the developmental platform network 110 are not limited to data centers and can utilize other types of remote network infrastructures. Moreover, other embodiments of the present disclosure may combine one or more different server instance into a single server instance. Using FIG. 2 as an example, the application server instances 210 and database server instances 212 may be combined into a single server instance. The use and discussion of FIGS. 1 and 2 are only examples to facilitate ease of description and explanation and are not intended to limit the disclosure to the specific examples illustrated therein.

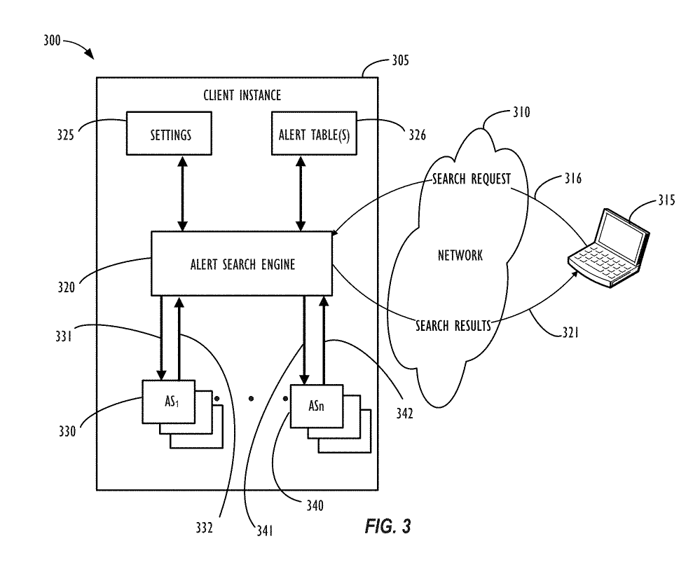

FIG. 3 illustrates a block diagram 300 of an embodiment of a network environment and hosted client instance 305 that may be used to support an improved CMDB alert display and prioritization system, according to one or more disclosed embodiments. As illustrated in FIG. 3, network 310 is a further example of a network such as the Internet or one or more corporate networks such as network 108 of FIG. 1 and network 204 of FIG. 2. In this example, network 310 may represent a single network or a combination of networks that may be configured to transmit a search request 316 from a client device 315 to an alert search engine 320 and return search results 321 from search engine 320 to client device 315.

Client device 315 may be configured to communicate through network 310 with client instance 305 that may be hosted on a remote server or a remote server instance in a cloud infrastructure, as described above. In this example, client device 315 may be configured to execute a web browser interface and receive a user indication of a search request 316 to be transmitted to client instance 305 and search engine 320 within that client instance 305 for processing. Search engine 320 may receive search request 316 and obtain informational settings 325 from within client instance 305 pertaining to the processing of search request 316. Alternatively, settings may be embedded within search request 316 without the need to reference settings 325.

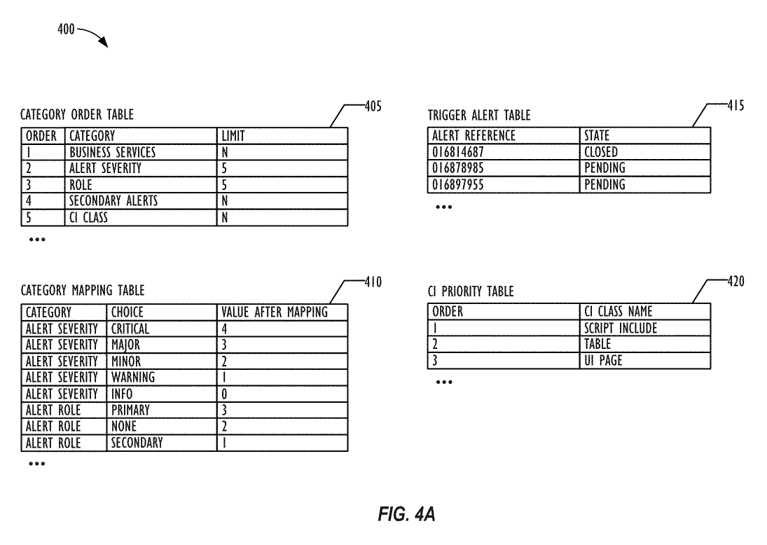

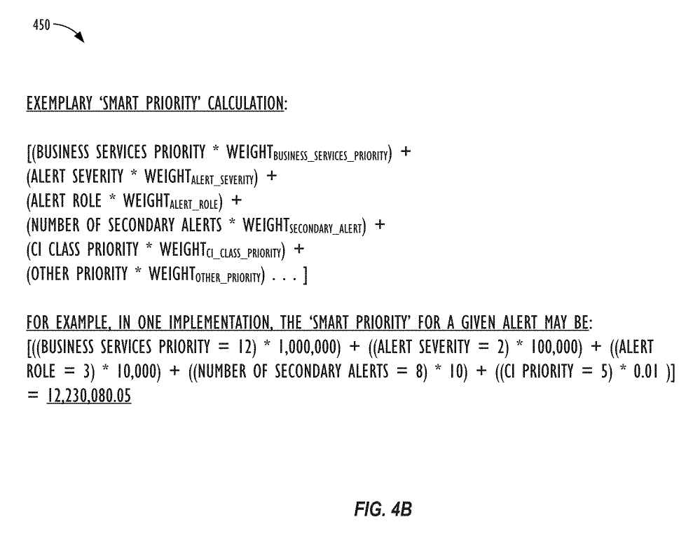

Once search engine 320 has obtained a sufficient amount of information pertaining to search request 316, the search process may be initiated to and from the various relevant tables storing alerts and alert metadata information (326), identifying the appropriate alert set results (330, 340) based on the respective search queries, as shown by interface lines 331, 341. As will be discussed in further detail with reference to FIG. 4A, in some embodiments, these relevant tables may be specifically configured to capture information regarding the categories, order, and value mappings of the various alert items. The search request 316 may, e.g., comprise the name of a particular alert, a partial name of a alert, an identification number of an alert, a type of CI related to an alert, one more desired characteristics of an alert, a vendor name, a machine or server name, a severity level of an alert, a priority level of an alert, a state of an alert, a date range, a physical location, etc., as well as a minimum or maximum number of alerts returned by the search request that the user wishes to pull back information for. Essentially, any piece of metadata regarding an alert (or related CI) that the system has captured information for may be searched on by the user that is sending search request 316.

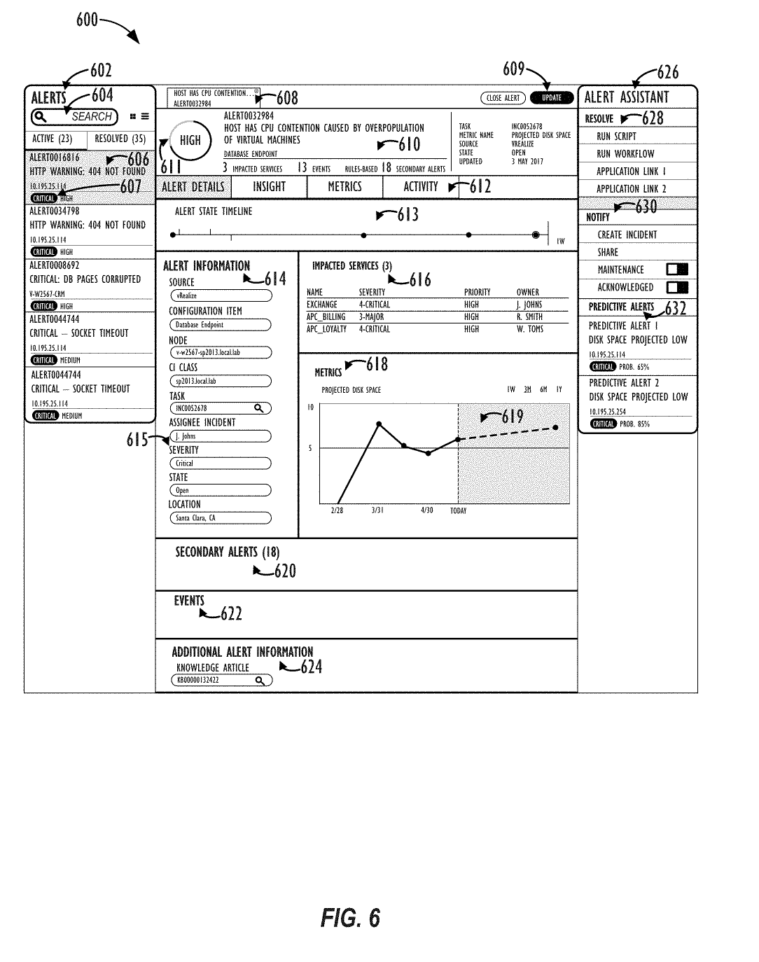

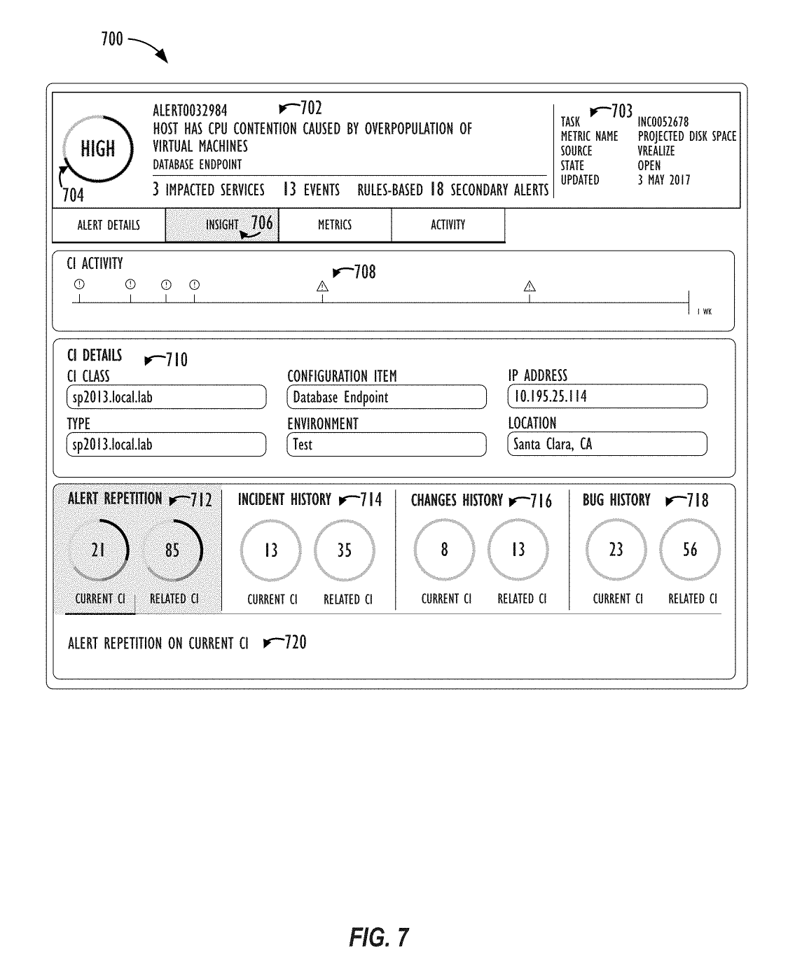

Each search request 316 may return a group of one or more alerts matching the search criteria from the aforementioned various relevant tables storing alert and related alert metadata information. For example, a first search request may return a group of alert objects, “Alert Set 1” (AS₁) 330, as shown by interface line 332, which will contain all the relevant alert items and related metadata necessary for the client instance 305 to generate a sorted list (or other desired data structure) allowing the user to view and/or traverse the results of the search request, as will be described in greater detail with reference to FIGS. 6-7. Likewise, additional search requests may be handled by search engine 320, returning different search results (e.g., partially overlapping search results with other search queries or search results that do not share overlapping results with other search queries), as represented in FIG. 3 by “AS group n” (ASₙ) 340, and as shown by interface line 342. Again, each returned AS group will contain all the relevant alert information and related metadata necessary for the for the client instance 305 to generate a sorted list data structure (or other desired data structure) for the respective search query, e.g., to be displayed on client device 315.

Block diagram 300 illustrates an example of a portion of a service provider cloud infrastructure (e.g., network 110 of FIG. 1) connected via a network 310, such as the Internet, to a customer device 315 to provide a user interface to network applications, executing within a client instance 305, via a web browser, as an example. Network 310 is a further example of a network such as network 108 of FIG. 1 and network 204 of FIG. 2. Details of these networks are discussed above with reference to each of FIGS. 1 and 2 and are not discussed further here. Service provider cloud infrastructure client instance 305 illustrates cloud resources and server instances similar to those explained with respect to FIG. 2, but is illustrated here to show support for an alert search capability within a single client instance 305. Of course, cloud provider infrastructure may be configured to support a plurality of end-user devices, such as end-user device 315, concurrently, wherein each end-user device is in communication with the single client instance 305. Also, cloud provider infrastructures may be configured to support any number of client instances, such as client instance 305, concurrently, with each of the instances in communication with one or more end-user devices. As mentioned above, an end-user may also interface with client instance 305 using an application that is executed within a web browser.

Referring now to FIG. 4A, a simplified diagram 400 of various database tables is shown, according to one or more embodiments of the present disclosure. The various database tables illustrated in FIG. 4A may be utilized to implement the smart prioritization system described herein. First, a category order table (405) may be employed, which may have at least the following fields: order, category, and limit. The order field may relate to the relevant importance of each of the various categories with respect to calculating the priority level of a given alert. For example, an order value of ‘1’ may be the most important category, whereas as an order value of ‘5’ may be an alert category that is less important to the alert's overall priority level. The categories may include, e.g., a business services criticality level, an alert severity level, a role, a number of secondary alerts, and/or a CI class. Of course, the categories and corresponding orders shown in table 405 are merely exemplary, and may vary from implementation to implementation, based on the needs of a given system. The limit column may store a maximum number of values for a given category (if there is such a maximum). A value of ‘N’ (or other predefined value) may be used in this field for a category with an unlimited number of potential values. According to some embodiments, the order column and the limit column may be utilized, in combination, to determine the weight value for a given category in a given implementation, as will be discussed in further detail below with respect to FIG. 4B. Values in each of the order column, category column, and/or limit column may each be changed by an authorized user of the system, as desired. Further, new rows may be added to the category order table as new categories for alerts become tracked by the system or relevant to the calculation of an alert's priority score.

A category mapping table (410) may also be employed, which may have at least the following fields: category, choice, and value (after mapping). As described above, the category field may correspond to the various categories as defined in category order table (405). For example, as shown in FIG. 4B, the category ‘alert severity’ may have the possible choices of: ‘critical’ (which maps to a value of ‘4’); ‘major’ (which maps to a value of ‘3’); ‘minor’ (which maps to a value of ‘2’); ‘warning’ (which maps to a value of ‘1’); and ‘info’ (which maps to a value of ‘0’). Likewise, the category ‘alert role’ may have the possible choices of: ‘primary’ (which maps to a value of ‘3’); ‘none’ (which maps to a value of ‘2’); ‘minor’ (which maps to a value of ‘2’); and ‘secondary’ (which maps to a value of ‘1’). Of course, the choices available for each category and corresponding values after mapping shown in table 4105 are merely exemplary, and may vary from implementation to implementation, based on the needs of a given system. Further, new rows may be added to the category mapping table as new categories choices become tracked by the system or relevant to the calculation of an alert's priority score.

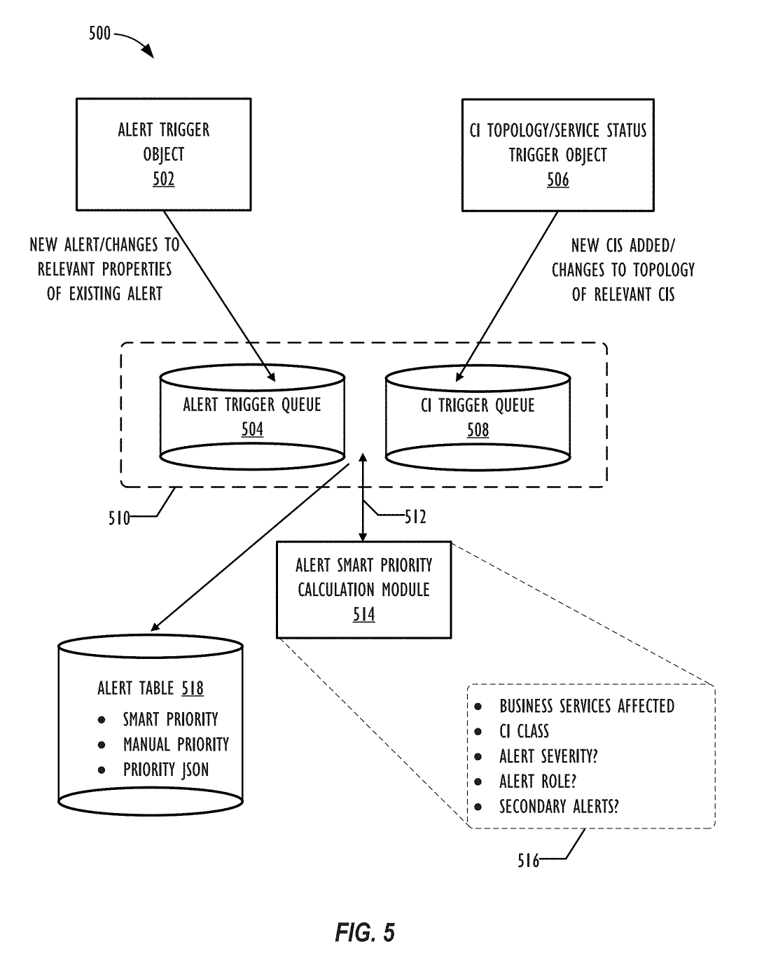

A trigger alert table (415) may also be employed, which may have at least the following fields: alert reference and state. The trigger alert table, which will be discussed in further detail below with reference to FIG. 5, may be used to collect and store the unique identifiers of all alerts (e.g., via the alert reference field) of all alerts for which some event has triggered the system to determine that a recalculation of a particular alert's priority score is needed (e.g., the addition of a new alert, a severity change of an existing alert, a role change of an existing alert, a change in the identity or type of a CI associated with a given alert, a change in the topology of CIs stored in the system, etc. The state column may include values such as, open (or pending), closed (or resolved), in process, etc., so that the status of a given alert may be taken into account when deciding if further processing and/or recalculation of the given alert's priority score is necessary. For example, if a given alert is in the “closed” state, there may be no need to continue to update its priority score (or the priority score of any of its ‘child’ alerts) any longer.

Finally, a CI Priority table (420) may also be employed, which may have at least the following fields: order and CI class name. The CI Priority table (420) may be used to support one or more various alert categories, such as the “CI class” category described above. As with the category order table (405), the order field may relate to the relevant importance of each of the various CI types with respect to calculating the priority level of a given alert associated with such CIs. For example, an alert relating to a ‘script include’ CI may be given a lower order (and thus higher priority) than an alert associated only with a User Interface (UI) page type of CI. As with the other tables mentioned with respect to FIG. 4A, the various values in the CI Priority table (420) may also be customized by users based on the needs of a given implementation.

Referring now to FIG. 4B, an exemplary alert smart priority calculation 450 is shown, according to one or more embodiments of the present disclosure. In the example of FIG. 4B, the five categories used in the ‘smart priority’ calculation are: ‘business services priority,’ ‘alert severity,’ ‘alert role,’ ‘number of secondary alerts,’ and ‘CI class priority.’ Each category also has a corresponding weight value which may, as described above, be based upon a combination of the respective categories ‘order’ value and ‘limit’ value in the category order table (405). Assuming that the weight of the ‘business services priority’ class is 1,000,000 and the alert's value for this category is 12, the weight of the ‘alert severity’ class is 100,000 and the alert's value for this category is 2, the weight of the ‘alert role’ class is 10,000 and the alert's value for this category is 3, the weight of the ‘number of secondary alerts’ class is 10 and the alert's value for this category is 8, and the weight of the ‘CI class priority’ class is 0.01 and the alert's value for this category is 5, then the final ‘smart priority’ value for the alert would be 12,230,080.05. As may now be understood, because ‘business services priority’ is weighted as the most important category in this exemplary smart priority calculation, the exemplary alert for which the calculation is shown in FIG. 4B would be ranked above any other alert that had a value of 11 or lower in the ‘business services priority’ category, regardless of what values such other alert may have in the other, lower-ranked, categories. According to some embodiments, the weights for each of the alert categories may comprise a numerical value that is a factor of ten. In this way, the value for each categories may be separated out into its own ‘digit’ place in the final calculated smart priority score, thus making the ranking and sorting operations more simple.

According to some embodiments, the calculation behind the smart priority score for a given alert may be stored in a metadata field along with the rest of the alert record, e.g., in the form of a JavaScript Object Notation (JSON) representation. It should be noted that it is not necessary to reveal the actual calculated smart priority value to the user of the system, although that is possible, if so desired. Rather, the smart priority value may simply be used to sort or rank the alert records returned to a user's console. As mentioned above, in some embodiments, the smart priority score may simply be used to group the various alert items into ‘buckets’ displayed on the user interface, e.g., based on the relative criticality of the alerts in each respective group, such as “High,” “Medium,” and “Low.” In this way, a user may prioritize his or her time to review or trouble shoot the “High” priority alert items first.

Referring now to FIG. 5, various components of a system 500 for calculating smart priorities for alert records are shown, according to one or more embodiments of the present disclosure. As mentioned above, according to some embodiments, a CMDB may comprise an alert trigger queue (504) for storing alert trigger objects (502) and a CI trigger queue (508) for storing objects reflecting changes in the topology or status of CIs stored in the CMDB (506). Alert trigger objects (502) may, e.g., comprise new alerts being added to the system, changes or updates to relevant properties of existing alerts (e.g., severity, role, number of secondary alerts etc.), and/or changes or updates to CIs related to an existing alert (e.g., parent CIs and/or child CIs). CI topology/service status objects (506) may, e.g., comprise and CIs newly added to the CMDB or changes to the topology of existing CIs in the system. The various trigger queues (510) may periodically be crawled by a process job (e.g., at a predetermined time interval or in response to a particular event) to obtain and open all pending (e.g., open) alert records that need to be processed, i.e., via the calculation of an updated priority score, based on the triggers currently stored in either trigger queue (510).

For each obtained alert record needing a priority recalculation, an alert smart priority calculation module (514) may be used to recalculate the smart priority score for each such alert, e.g., according to a smart priority calculation method, such as those described above with reference to FIGS. 4-5. As mentioned above, various categories (516) may go into the calculation of the smart priority score, and the various categories may each be weighted independently of each other in the calculation of the final smart priority value for each given alert. According to some embodiments, the alert smart priority calculation module (514) may proceed by, for each alert, building a set of all the CIs (e.g., business services) impacted by the respective alert and its secondary alerts, then determining the business criticality of each such impacted services. Next, the relevant weights for each relevant alert category may be pulled or determined from the category order table (405). Next, the information relevant to each category may be located (e.g., the alert severity, alert role, number of secondary alerts, CI class priority, etc.) so that the updated smart priority value for the alert may be calculated, as described above. Finally, the priority value of the processed alerts may be updated, e.g., via batch update operation.

The alert prioritization schemes described herein may also necessitate one or more changes to existing table schema, such as the inclusion of additional fields in an alert table (518). For example, the alert table (518) may be modified to include a new column for the aforementioned smart priority score value that is calculated for each alert. The alert table (518) may also be modified to include a ‘manual priority’ column (e.g., in the form of a Boolean value) to allow for system to track whether the user has overridden the calculated smart priority value for a given alert and instead entered a manual priority for the alert (and/or ‘dragged’ the alert into a different category via the user interface). In some embodiments, the value of the smart priority calculated by the system prior to the user's manual modification may also be tracked by the alert table (518), e.g., in the event that the user wishes to return the alert to its priority value from prior to the manual manipulation by the user. Finally, as described above, the alert table (518) may also store a column for the string representation of the priority calculation itself, e.g., in the form of a structured JSON object, so that subsequent changes to the values of one or more of an alert's category values may be processed more readily and/or so that not all categories going into the smart priority score have to be recalculated any time that a single category value for the alert changes.

Referring now to FIG. 6, an exemplary user interface page 600 for viewing information related to alert records is shown, according to one or more embodiments of the present disclosure. As may be understood, FIG. 6 provides merely one exemplary user interface, and different user interfaces, including user-customizable user interfaces, may be employed based on the needs or desires of a given implementation.

Exemplary user interface page 600 is shown as divided into three columns. In the left column of user interface page 600 is an alert panel 602. Alert panel 602 may be used to provide a quick overview (606) of a subset of the alerts stored in the system. For example, alert panel 602 may show only those alerts that were returned from the last alert query executed by the user, e.g., via search box functionality 604. The alert panel 602 may also be filtered by various alert properties, e.g., CI type, alert severity, source, services impacted, etc. Alternately, alert panel 602 may show the most recent ‘n’ alerts, the most critical ‘n’ alerts, the most repeated ‘n’ alerts, etc. In some embodiments, the smart priority value may be converted into a simple criticality ranking (607), such a “High,” “Medium,” or “Low.” In this way, users may easily tell at a glance which alerts are the most critical for them to respond to, even without needing to know the precise smart priority calculation (or smart priority score value) that went into determining the criticality ranking of the alert. The alerts in alert panel 602 may also be filtered by other factors, such as: only active alerts, only resolved alerts, only alerts that are ‘in process’ of being resolved, etc.

In the central column of user interface page 600 is a detailed alert information pane 610. The detailed alert information pane 610 may support a tabbed interface (608), allowing the user to easily switch between viewing the detailed information of one or more open alert items. As shown in FIG. 6, the detailed alert information pane 610 may present various alert-related information items to the user, including: a visual indication of the alert's criticality (611); the system identifier number of the alert; the type of CI associated with the alert (e.g., a “database endpoint”); the number of impacted services, events, and/or secondary alerts associated with the alert; the task name associated with the alert; the metric name(s) being tracked with respect to the alert (e.g., projected disk space); the source of the alert; the current state of the alert (e.g., open, pending, closed, etc.); and the date and/or time of the last time the alert record was updated.

Alert information pane 610 may also comprise additional tabs (612) for displaying further detailed information about the alert, insights about the alert (e.g., its causes, potential solutions), metrics about the alert, and/or alert activity over time. An alert information panel (614) may, e.g., provide the various categories (615) of information discussed above (or others), such as: the source of an alert; the type, name, or class of CI associated with the alert; the task associated with the alert; the individual assigned to the alert; the severity of the alert; the current state of the alert; and/or the location of the alert. According to some embodiments, the user may be able to modify or override the data in one or more of the fields shown in alert information panel (614), assuming they have sufficient authority. For example, a user may wish to assign a different individual to an incident, modify the state of an alert (e.g., if it has been resolved), etc.

Alert information pane 610 may also comprise a listing of the business services impacted by the currently-selected alert (616), for example, in tabular form. The display may also include the name, severity, priority, and owner/assignee of such impacted services, so that the user may determine whether or not it is necessary to contact the owner/assignee of such impacted services, e.g., to warn them of potential adverse effects to their services, as well as links to such impacted services, e.g., to view a service map and/or drill down to get more data related to a particular impacted service.

Alert information pane 610 may also comprise a metrics sub-pane (618), which may, e.g., display one or more metrics tracked by the system relevant to the currently-selected alert, including links thereto. This metric may comprise, e.g., a projected amount of disk space remaining on a particular node in the enterprise system. This information may also be converted into a graphical display for convenience and ease of use, e.g., a line graph (619) or bar chart, so that a user may track the value of a given metric over time and perhaps identify or discover new trends in such metric, anticipate when such metric may be likely to exceed an acceptable operational threshold, or prevent the metric from exceeding the acceptable operational threshold altogether.

Alert information pane 610 may also comprise various other detailed sub-panels, e.g., related to secondary alerts (620), events (622), or whatever other relevant information may be tracked for an alert in a given enterprise implementation. Finally, there may also be a detailed sub-panel dedicated to additional alert information (624), such as knowledge articles with information regarding the currently-selected alert, potential troubleshooting solutions, financial aspects of the currently-selected alert (if applicable), correlated alerts, and/or a place for a user to provide feedback regarding the currently-selected alert, etc. When a user is done examining the additional alert information on a given alert, he or she may simply click the button to close the alert or update the alert (609), with whatever changes or modifications the user may have made to the alert's metadata.

In the right column of user interface page 600 is an alert assistant pane 626. The alert assistant pane 626 may comprise links to one or more possible resolution methods (628), such as scripts or workflows that may be run by the system to attempt to diagnose or correct the system error condition that is generating the currently-selected alert. The resolution methods (628) may also include links to one or more applications that may provide further information or assistance to the user in handling the alert. In some embodiments, the system may provide one or more out-of-the-box′ workflows for common tasks, which workflows may be dynamically adjusted, e.g., based on machine learning over time—or even applied automatically by the system in an effort to ‘heal’ itself without requiring user intervention at all.

The alert assistant pane 626 may also comprise links to one or more alert notification methods (630), such as creating an incident report for the alert, sharing the alert with one or more other users of the system (e.g., via a chat or “war room”-type interface), indicating that a given CI needs maintenance to be performed on it, and/or acknowledging the alert.

In some embodiments, the alert assistant pane 626 may also comprise a sub-panel for displaying one or more “predictive” alerts (632). Predictive alerts may comprise alerts for which the triggering condition has not yet occurred but where, e.g., based on an analysis of historical activity and/or a prediction of likely future activity, the application of machine learning or other artificial intelligence techniques, and/or the analysis of metric trends over time, the system has determined with some level of confidence or probability that a given alert may soon be triggered. For example, if there are 10 gigabytes of disk space remaining on a given node, and the disk space has been decreasing at the rate of 1 gigabyte an hour, the system may be able to issue a predictive alert that there will be a disk space projected low alert at some point in the next 10 hours for the given node. The use of predictive alerts may, in fact, allow users of the system to identify, triage, report, assign and/or troubleshoot certain system conditions before they even raise to the level of being a system alert. In other embodiments, the contents of alert assistant pane 626 itself may be auto-adjusted or populated based on the use of machine learning techniques, e.g., based on the most successful methods of resolving or notifying a given type of alert in the past.

Referring now to FIG. 7, another exemplary user interface page 700 for viewing information related to alert records is shown, according to one or more embodiments of the present disclosure. User interface page 700 may, e.g., represent the detailed alert information pane 610 from the center column of user interface page 600 discussed above with reference to FIG. 6 after the user has selected the “Insight” tab 706 from among additional tabs (612). Exemplary user interface page 700 may comprise the same alert metadata information (702/703) as was discussed for the currently-selected alert in reference to FIG. 6 above, including a visual indication of the alert's criticality (704). The additional insight information from the currently-selected alert information may comprise: a timeline of CI activity (708), e.g., showing a visual record of repeated incidents, alerts, changes, logged bugs, etc., with respect to the CI associated with the currently-selected alert over some time period, e.g., a day, week, month, or year.

Exemplary user interface page 700 may further comprise a sub-pane for CI details (710), such as the CI's class, type, name, IP address, location, and/or the name of the environment in which the CI is connected. Exemplary user interface page 700 may further comprise one or more additional sub-panes related to: alert repetition (712); incident history (714); changes history (716); and/or logged bug history (718). According to some embodiments, each of these further sub-panes may be able to be further broken down into statistics relevant to the current CI, i.e., associated with the currently-selected alert or to all related CIs. Related CIs may comprise, e.g., parent CIs (e.g., within a Level-1 or Level-2 relationship of selected CI), child CIs (e.g., within a Level-1 or Level-2 relationship of selected CI), CIs of a similar type, CIs performing the same service, CIs at a similar location, or CIs in a similar environment, etc. This type of information may provide further insight to the user as to whether a current alert is unique to a particular CI or is endemic to all CIs of that type (and, thus, likely to be an alert that is soon to be triggered on one or more additional related CIs in the future). Additional information related to a specific selected sub-pane may be displayed in sub-pane 720, e.g., information on the number of times a given alert has been repeated for the current CI (or related CIs) over a given time period.

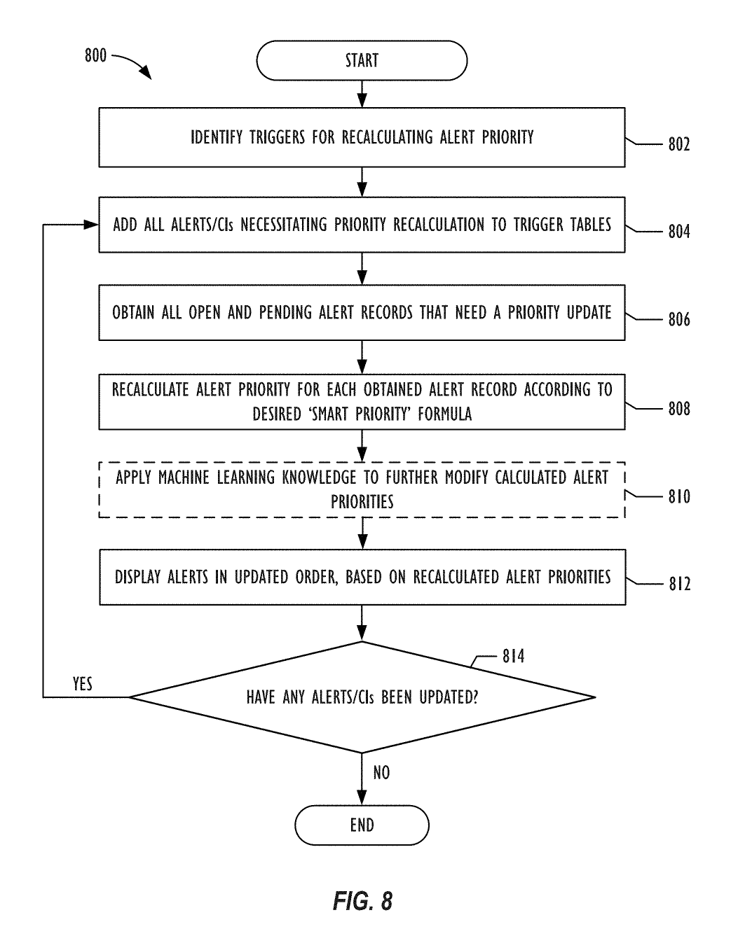

Referring now to FIG. 8, a flowchart 800 of an embodiment of a method that calculates smart priorities for alert records is shown. Method 800 starts, at Step 802, by identifying the system triggers that will be tracked and used to trigger the recalculation of the alert priority of alerts in the system. Next, once the types of system triggers have been identified, at Step 804, the alerts and/or CIs that should be triggered may be added to their respective queues. Special care may be taken with regard to tracking an alert's state (e.g., there may be a new trigger for an alert that is already in an ‘in progress’ state that still needs to be added to the alert trigger queue, while alerts that are ‘closed’ need not be added to the alert queue). At Step 806, the method may execute a process job to obtain all the open and pending alert records that have been identified as needing an alert priority value recalculation, e.g., based on receiving one or more related triggers. Next, at Step 808, the method may recalculate the alert priority value for each obtained alert, e.g., according to a desired ‘smart priority’ formula, such as the various smart priority formulae described above with reference to FIGS. 4-5. Next, at Step 810, the method may optionally apply one or more machine learning techniques to further modify the calculated alert priority values. For example, the calculated ‘smart priority’ score for a given alert may be further modified (or replaced altogether) via the application of supervised or semi-supervised machine learning techniques, based on historical user activity data, mean time to resolution, or feedback for the CMDB (or from across multiple CMDB customers over time). Such techniques may involve, e.g., the use of neural networks with feedback. Machine learning techniques may be employed on a per-organization, per sub-organization, or global basis. Finally, at Step 812, the alerts may be displayed via a user interface, e.g., such as the user interfaces described above with reference to FIGS. 6-7, in an updated order, based on the recalculated alert priorities.

If, after the passage of some predetermined amount of time (or upon determination that new items have been added to either trigger queue (510), it is determined that additional alerts and/or CIs have been updated (i.e., ‘Y’ at Step 814), the method may return to Step 804 to begin the processing of the new triggers and the recalculation of the priority values of the relevant alert records. If, instead, however, it is determined that no new items have been added to either trigger queue (510), or that alert reprioritization calculations are no longer desired (i.e., ‘N’ at Step 814), the method may end. Of course, as long as the system is continuing to monitor and re-prioritize alerts, the method 800 will effectively need to be run continuously so that alert and/or CI triggers may be processed in real-time (or with no greater than a maximum permissible lag time).

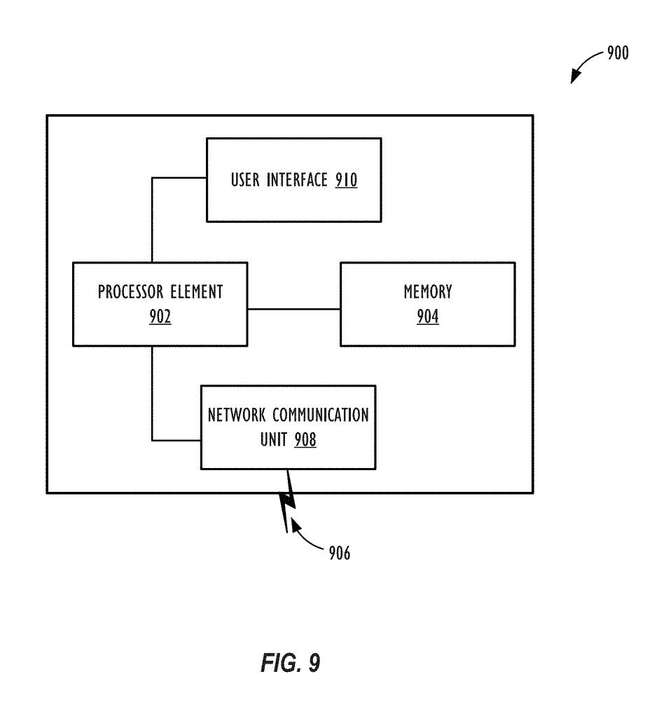

Referring now to FIG. 9, a block diagram illustrates a computing device 900 that may be used for implementing one or more of the techniques described herein. For example, the computing device 900 illustrated in FIG. 9 could represent a client device or a physical server device. As shown in FIG. 9, the computing device 900 can include can also include one or more input/output devices, such as a network communication unit 908 that could include a wired communication component and/or a wireless communications component 906, which can be coupled to processor element 902. The network communication unit 908 can utilize any of a variety of standardized network protocols, such as Ethernet, TCP/IP, to name a few of many protocols, to effect communications between devices and comprise one or more transceiver(s) that utilize the Ethernet, power line communication (PLC), WiFi®, and/or other communication methods.

The computing system 900 includes a processing element 902 that contains one or more hardware processors, where each hardware processor may have a single or multiple processor cores. In one embodiment, the processing element 902 may include at least one shared cache that stores data (e.g., computing instructions) that are utilized by one or more other components of processing element 902. For example, the shared cache may be locally cached data stored in a memory for faster access by components of the processing elements 902. In one or more embodiments, the shared cache may include one or more mid-level caches, such as level 2 (L2), level 3 (L3), level 4 (L4), or other levels of cache, a last level cache (LLC), or combinations thereof. Examples of processors include, but are not limited to a central processing unit (CPU) such as a microprocessor. Although not illustrated in FIG. 9, the processing element 902 may also include one or more other types of hardware processing components, such as graphics processing units (GPU), application specific integrated circuits (ASICs), field-programmable gate arrays (FPGAs), and/or digital signal processors (DSPs).

FIG. 9 illustrates that memory 904 may be operatively coupled to processing element 902. Memory 904 may be a non-transitory medium configured to store various types of data. For example, memory 904 may include one or more memory devices that comprise a non-volatile storage device and/or volatile memory. Volatile memory, such as random access memory (RAM), can be any suitable non-permanent storage device. The non-volatile storage devices can include one or more disk drives, optical drives, solid-state drives (SSDs), tap drives, flash memory, read only memory (ROM), and/or any other type memory designed to maintain data for a duration time after a power loss or shut down operation. In certain instances, the non-volatile storage device may be used to store overflow data if allocated RAM is not large enough to hold all working data. The non-volatile storage device may also be used to store programs that are loaded into the RAM when such programs are selected for execution.

Persons of ordinary skill in the art are aware that software programs may be developed, encoded, and compiled in a variety computing languages for a variety software platforms and/or operating systems and subsequently loaded and executed by processing element 902. In one embodiment, the compiling process of the software program may transform program code written in a programming language to another computer language such that the processing element 902 is able to execute the programming code. For example, the compiling process of the software program may generate an executable program that provides encoded instructions (e.g., machine code instructions) for processor 902 to accomplish specific, non-generic, particular computing functions.

After the compiling process, the encoded instructions may then be loaded as computer executable instructions or process steps to processing element 902 from storage (e.g., memory 904) and/or embedded within the processing element 902 (e.g., cache). Processing element 902 can execute the stored instructions or process steps in order to perform instructions or process steps to transform the computing device into a non-generic, particular, specially programmed machine or apparatus. Stored data, e.g., data stored by a storage device, can be accessed by processing element 902 during the execution of computer executable instructions or process steps to instruct one or more components within the computing device 900.

A user interface 910 can include a display, positional input device (such as a mouse, touchpad, touchscreen, or the like), keyboard, or other forms of user input and output devices. The user interface 910 can be coupled to processor element 902. Other output devices that permit a user to program or otherwise use the computing device can be provided in addition to, or as an alternative to, network communication unit 908. When the output device is (or includes) a display, the display can be implemented in various ways, including by a liquid crystal display (LCD), a cathode-ray tube (CRT), or a light emitting diode (LED) display, such as an organic LED (OLED) display. Persons of ordinary skill in the art are aware that the computing device 900 may comprise other components well known in the art, such as sensors, powers sources, and/or analog-to-digital converters, not explicitly shown in FIG. 9. For ease of discussion, FIG. 9 does not include further explanation of these other components well known in the art.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations may be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

Use of the term “optionally” with respect to any element of a claim means that the element is required, or alternatively, the element is not required, both alternatives being within the scope of the claim. Use of broader terms such as comprises, includes, and having may be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. It should be noted that the discussion of any reference is not an admission that it is prior art to the present invention, especially any reference that may have a publication date after the priority date of this application

What is claimed is:

1. A system, comprising:
a first trigger queue (504);
a second trigger queue (508);
a priority score calculation module (514);
a non-transitory memory; and
one or more hardware processors configured to read instructions from the non-transitory memory to cause the system to:
store one or more alert items in the first trigger queue (504);
store one or more topology change items or service status change items in the second trigger queue (508);
for each alert item in the first trigger queue (504):
obtain a score value from a category mapping table (410) in each of one or more categories, wherein each score value relates to a characteristic or degree of the corresponding category in the respective alert item;
obtain a weight value from a category order table (405) corresponding to each of the one or more categories, wherein each weight value relates to an importance or criticality of the corresponding category; and
calculate, with priority score calculation module (514), a priority score for the respective alert item by adding together the products of each of the one or more score values for the respective alert item and its corresponding weight value; and
display the one or more alert items on a user interface, wherein the one or more alert items are sorted based, at least in part, on their respective priority scores.

2. The system of claim 1, wherein at least one of the one or more categories comprises: a number of services affected by the respective alert item; a severity level of the respective alert item; a role of the respective alert item; a number of secondary alert items for the respective alert item; or a class of Configuration Item (CI) associated with the respective alert item.

3. The system of claim 1, wherein the instructions to cause the system to display the one or more alert items on a user interface further comprise instructions to:
group the one or more alert items into one or more groups based, at least in part, on the respective priority scores of the one or more alert items.

4. The system of claim 1, wherein the instructions to cause the system to calculate a priority score for a respective alert item of the one or more alert items further comprise instructions to:
apply one or more supervised or semi-supervised machine learning techniques to historical user activity data for the system.

5. The system of claim 1, wherein the instructions to cause the system to calculate a priority score for a respective alert item of the one or more alert items further comprise instructions to:
recalculate the priority score for the respective alert based, at least in part, upon one or more items stored in the second trigger queue (508).

6. The non-transitory program storage device of claim 5, wherein at least one of the one or more items stored in the second trigger queue (508) comprises: a change in the number of services affected by the respective alert item; a change in number or class of CI associated with the respective alert item; a change in the number of secondary alert items for the respective alert; an addition of one or more CIs to the system; or a deletion of one or more CIs from the system.

7. A non-transitory program storage device, readable by a programmable control device and comprising instructions stored thereon to cause one or more programmable control devices to:
receive one or more alerts related to CIs stored in a configuration management database (CMDB);
obtain a score value for the each of the one or more alerts in each of one or more alert categories;
obtain a weight value corresponding to each of the one or more alert categories for each of the one or more alerts; and
calculate a priority score for each of the one or more alerts, wherein calculating the priority score for a respective alert of the one or more alerts comprises determining a summation of the products of each of the one or more score values for the respective alert with its corresponding weight value; and
display the one or more alerts on a user interface, wherein the one or more alerts are sorted based, at least in part, on their respective priority scores.

8. The non-transitory program storage device of claim 7, wherein at least one of the one or more alert categories comprises: a number of services affected by the respective alert; a severity level of the respective alert; a role of the respective alert; a number of secondary alerts for the respective alert; or a class of CI associated with the respective alert.

9. The non-transitory program storage device of claim 7, wherein each of the one or more alert categories has a different corresponding weight value.

10. The non-transitory program storage device of claim 9, wherein each of the weight values corresponding to the one or more alert categories comprises a numerical value that is a factor of ten.

11. The non-transitory program storage device of claim 7, wherein the instructions to cause one or more programmable control devices to display the alerts on a user interface further comprise instructions to:
group the one or more alerts into one or more groups based, at least in part, on the respective priority scores of the one or more alerts.

12. The non-transitory program storage device of claim 11, wherein the one or more groups reflect a criticality of the alerts in each respective group.

13. The non-transitory program storage device of claim 7, wherein the instructions to cause one or more programmable control devices to calculate a priority score for a respective alert of the one or more alerts further comprise instructions to:
apply one or more supervised or semi-supervised machine learning techniques to historical user activity data for the CMDB.

14. The non-transitory program storage device of claim 7, wherein the instructions to cause one or more programmable control devices to calculate a priority score for a respective alert of the one or more alerts further comprise instructions to:
recalculate the priority score for the respective alert upon an occurrence of one or more triggers.

15. The non-transitory program storage device of claim 14, wherein at least one of the one or more triggers comprises: a change in the number of services affected by the respective alert; a change in severity of the respective alert; a change in role of the respective alert; a change in number or class of CI associated with the respective alert; a change in the number of secondary alerts for the respective alert; a passage of a predetermined amount of time; an addition of one or more CIs to the CMDB; or a deletion of one or more CIs from the CMDB.

16. The non-transitory program storage device of claim 7, wherein information reflecting how the priority score for a respective one of the one or more alerts was calculated is stored as metadata within the respective alert.

17. The non-transitory program storage device of claim 16, wherein the metadata comprises a JavaScript Object Notation (JSON) representation of the information reflecting how the priority score for the respective one of the one or more alerts was calculated.

18. The non-transitory program storage device of claim 7, further comprising instructions to cause the one or more programmable control devices to:
store, in the CMDB, historical priority score information for the one or more alerts over a first period of time.

19. A computer-implemented method, comprising:
receiving one or more alerts related to CIs stored in a configuration management database (CMDB);
obtaining a score value for the each of the one or more alerts in each of one or more alert categories;
obtaining a weight value corresponding to each of the one or more alert categories for each of the one or more alerts; and
calculating a priority score for each of the one or more alerts, wherein calculating the priority score for a respective alert of the one or more alerts comprises determining a summation of the products of each of the one or more score values for the respective alert with its corresponding weight value; and
displaying the one or more alerts on a user interface, wherein the one or more alerts are sorted based, at least in part, on their respective priority scores.

20. The method of claim 19, wherein at least one of the one or more alert categories comprises: a number of services affected by the respective alert; a severity level of the respective alert; a role of the respective alert; a number of secondary alerts for the respective alert; or a class of Configuration Item (CI) associated with the respective alert.
